(19) United States
(12) Patent Application Publication
(10) Pub. No.: US 2007/0084682 A1
(43) Pub. Date: Apr. 19, 2007

(54) PARKING BRAKE ADJUSTMENT FOR AN AIRCRAFT HAVING AN ELECTRIC BRAKE SYSTEM

(76) Inventors: T. Todd Griffith, Seattle, WA (US); Erik Godo, Redmond, WA (US)

Correspondence Address: INGRASSIA FISHER & LORENZ, P.C., 7150 E. CAMELBACK RD., SUITE 325, SCOTTSDALE, AZ, 85251, US

(21) Appl. No.: 11/532,487

(22) Filed: Sep. 15, 2006

Related U.S. Application Data
(63) Continuation of application No. 09/919,728, filed on Jul. 31, 2001, now Pat. No. 7,184,408.

(51) Int. Cl. F16D 65/36

(52) U.S. Cl. 188/156

(57) ABSTRACT

A system and procedures for adjusting a parking brake for an aircraft having an electric brake system are disclosed. Adjustment of a parking brake as described herein can compensate for thermal expansion or contraction of components of a parking brake mechanism, generally seen during and subsequent to an aircraft landing. Procedures for adjusting an aircraft parking brake as disclosed herein include setting the aircraft brakes to an initial state, comparing a measured elapsed time to a threshold time, measuring a brake temperature, adjusting the brakes to achieve a desired clamping force or brake actuator position, and engaging a friction brake in order to conserve power needed by an electric brake actuator.

### TECHNICAL FIELD

Embodiments of the present invention relate generally to aircraft braking systems. More particularly, embodiments of the present invention relate to a method and system for adjusting a parking brake of an electric brake system in response to changing brake temperature.

### BACKGROUND

Upon landing and braking, aircraft brake components will see greatly increased temperatures due to braking friction. These increased temperatures and the subsequent cooling period may cause thermal expansion and contraction of brake components which may result in increased or decreased clamping force. Decreased clamping force is generally experienced as brake components expand with increased temperature. If this occurs after an aircraft has been parked and the parking brake has been set, the integrity of the parking brake may be compromised. On the other hand, an increase in clamping force may be seen as brake components cool down and contract, the result of which may be damage to components.

For aircraft employing hydraulic brakes, an “automatic” adjustment feature is typically available such that a constant hydraulic pressure is applied to the brakes as the brake structure and brake material heats and cools. In an electric brake system, however, where an electric motor and gear train is used to compress the brake, there is no automatic adjustment mechanism that maintains pressure on the brake when the brake heats or cools. The brake either loses compression pressure, or the brake pressure increases and causes the electric motor and gear train to be stressed or damaged.

### BRIEF SUMMARY

A method and system are provided for adjusting a parking brake for an aircraft having an electric brake system. Adjustment of a parking brake as described herein is advantageous because the system and procedures can compensate for thermal expansion or contraction of components of a brake mechanism. Adjustment of an aircraft parking brake to compensate for transient thermal characteristics of the brake is desirable for preventing the aircraft from rolling while in a parked condition and also for reducing the risk of damaging brake components. Additionally, embodiments of the system and methods provided herein are capable of conserving power, thereby extending the battery life of the aircraft and potentially decreasing the weight and size of the aircraft battery.

The above and other aspects of the invention may be carried out in one embodiment by a method for setting and adjusting an aircraft parking brake. As described herein, this embodiment includes setting the brake to an initial state, comparing a measured elapsed time to a threshold time, adjusting the brake to a predetermined clamping force or actuator position, and engaging a friction brake in order to conserve power needed by an electric brake actuator.

Another embodiment of the invention is a method for setting and adjusting a parking brake to compensate for transient thermal properties of the brake, where adjustments are made based on measured temperatures. This method includes setting the brake to an initial state, measuring a brake temperature, comparing a variation in brake temperature to a threshold variation, adjusting the brake to a predetermined clamping force or actuator position, and engaging a friction brake in order to conserve power needed by an electric brake actuator.

The invention may also be embodied as a system for adjusting an aircraft parking brake to compensate for transient thermal properties of the brake, the system comprising a parking brake mechanism, a brake system control unit, an electric brake actuator control, and an electric brake actuator.

Furthermore, other desirable features and characteristics of embodiments of the present invention will become apparent from the subsequent detailed description and the appended claims, taken in conjunction with the accompanying drawings and the foregoing technical field and background.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a schematic representation of an example embodiment of an electric brake system for an aircraft;

FIG. 2 is a diagram that schematically illustrates thermal expansion and contraction of an aircraft brake mechanism;

FIG. 3 is a side view illustrating brake actuator placement relative to a brake rotor;

FIG. 4 is a block diagram that illustrates several components of an electric brake system;

FIG. 5 is a flow chart of a parking brake adjustment process, where adjustments are made at threshold times;

FIG. 6 is a flow chart of a parking brake adjustment process, where adjustments are made based on measured temperatures; and

FIG. 7 is a flow chart of a process for setting an electric brake.

### DETAILED DESCRIPTION

The following detailed description is merely illustrative in nature and is not intended to limit the embodiments of the invention or the application and uses of such embodiments. Furthermore, there is no intention to be bound by any expressed or implied theory presented in the preceding technical field, background, brief summary or the following detailed description.

Embodiments of the invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present invention may be practiced in conjunction with a variety of different aircraft brake systems and aircraft configurations, and that the system described herein is merely one example embodiment of the invention.

For the sake of brevity, conventional techniques and components related to signal processing, aircraft brake systems, brake system controls, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the invention.

The following description refers to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically. Thus, although the schematic representations shown in the figures depict example arrangements of elements, additional intervening elements, devices, features, or components may be present in an embodiment of the invention.

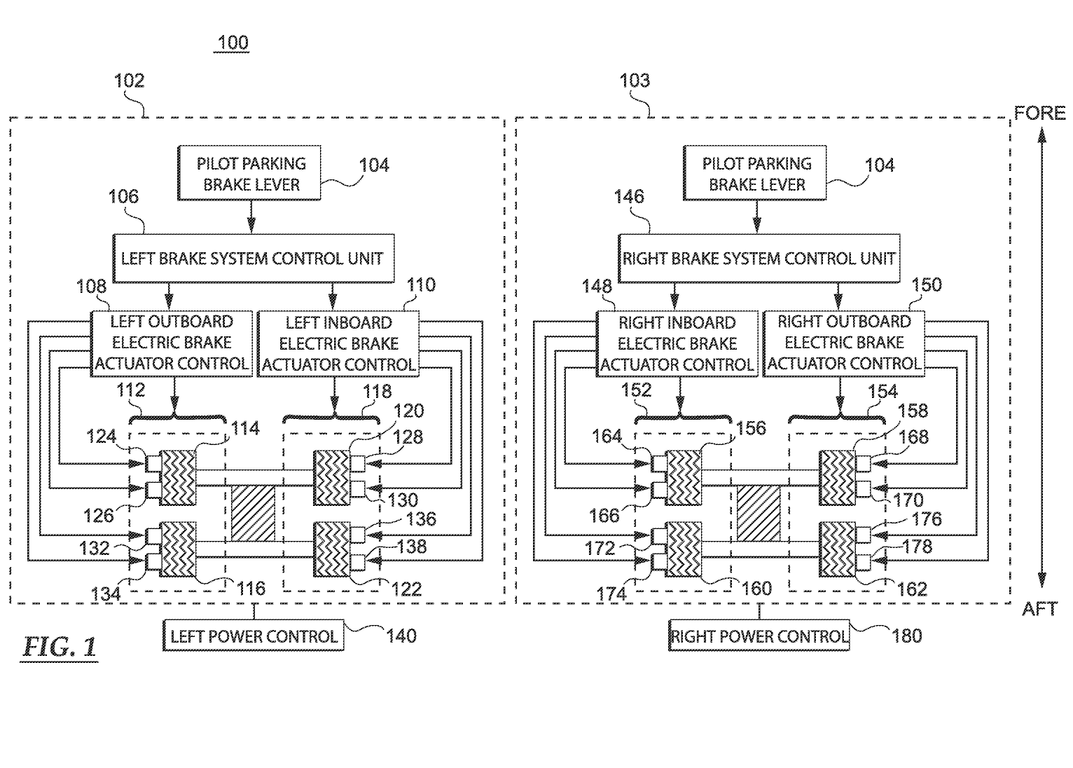

FIG. 1 is a schematic representation of an example embodiment of an electric brake system 100 for an aircraft. In the example embodiment shown in FIG. 1, the aircraft employs a left side electric brake subsystem architecture 102 and a right side electric brake subsystem architecture 103, which are similarly configured. The terms “left” and “right” refer to the port and starboard of the aircraft, respectively. In practice, the two subsystem architectures 102/103 may be independently controlled in the manner described below. For simplicity, only left side electric brake subsystem architecture 102 is described in detail below. It should be appreciated that the following description also applies to right side electric brake subsystem architecture 103.

For this example deployment, left side electric brake subsystem architecture 102 generally includes: a pilot parking brake lever 104; a brake system control unit (BSCU) 106 coupled to pilot parking brake lever 104; an outboard electric brake actuator control (EBAC) 108 coupled to BSCU 106; an inboard EBAC 110 coupled to BSCU 106; an outboard wheel group 112 that includes a fore wheel 114 and an aft wheel 116; an inboard wheel group 118 that includes a fore wheel 120 and an aft wheel 122; electric brake actuators (reference numbers 124, 128, 132, and 136) coupled to the EBACs, and friction brakes (reference numbers 126, 130, 134, and 138) coupled to the EBACs. The electric brake actuators and the friction brakes correspond to each wheel for the left side electric brake subsystem architecture 102. Although not shown in FIG. 1, an embodiment may have more than one electric brake actuator and more than one friction brake per wheel.

The elements in left side electric brake subsystem architecture 102 can be coupled together using a data communication bus or any suitable interconnection arrangement or architecture. For example, a digital data communication bus or buses may be configured to communicate EBAC control signals from BSCU 106 to the EBACs, to communicate brake mechanism control signals (e.g., actuator control signals) from the EBACs to the electric brake actuators, to communicate friction brake control signals, etc. Briefly, BSCU 106 reacts to manipulation of pilot parking brake lever 104 and generates control signals that are received by EBACs 108/110. In turn, EBACs 108/110 generate brake actuator control signals that are received by the electric brake actuators. In turn, the brake actuators engage to impede or prevent rotation of their respective wheels. These features and components are described in more detail below.

Pilot parking brake lever 104 is configured to provide pilot input to electric brake system 100. In one embodiment, the aircraft employs one pilot parking brake lever to control the application of parking brakes for all wheels on the aircraft. In other words, pilot parking brake lever 104 may be shared by both electric brake subsystem architectures on the aircraft. The pilot physically manipulates pilot parking brake lever 104 to engage the parking brake of the aircraft. This engagement of pilot parking brake lever 104 may be measured by a hardware servo or an equivalent component, converted into a parking brake command control signal by a transducer or an equivalent component, and sent to BSCU 106.

BSCU 106 is an electronic control unit that has embedded software that digitally computes EBAC control signals that represent braking commands and parking brake commands. The electrical/software implementation allows further optimization and customization of braking performance and parking brake actuation and control as needed for the given aircraft deployment. As described in more detail below, BSCU 106 is suitably configured to generate brake control signals that compensate for thermally induced dimensional changes of the brake mechanism of the aircraft. Such dimensional changes may occur in response to heating of the brake mechanism during deceleration braking maneuvers following landing.

Each BSCU in electric brake system 100 may be implemented or performed with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. A processor may be realized as a microprocessor, a controller, a microcontroller, or a state machine. A processor may also be implemented as a combination of computing devices, e.g., a combination of a digital signal processor and a microprocessor, a plurality of microprocessors, one or more microprocessors in conjunction with a digital signal processor core, or any other such configuration. In one embodiment, each BSCU is implemented with a computer processor (such as a PowerPC 555) that hosts software and provides external interfaces for the software.

BSCU 106 monitors various aircraft inputs to provide control functions such as, without limitation: pedal braking; parking braking; automated braking; and gear retract braking. In addition, BSCU 106 blends antiskid commands (which could be generated internally or externally from BSCU 106) to provide enhanced control of braking. BSCU 106 obtains pilot command control signals from brake pedals (not shown), along with parking brake command control signals from pilot parking brake lever 104. BSCU 106 processes its input signals and generates one or more EBAC control signals that are received by EBACs 108/110. In practice, BSCU 106 transmits the EBAC control signals to EBACs 108/110 via a digital data bus. In a generalized architecture (not shown), each BSCU can generate independent output signals for use with any number of EBACs under its control.

Each EBAC in electric brake system 100 is coupled to and controlled by a BSCU. Each EBAC in electric brake system 100 may be implemented, performed, or realized in the manner described above for the BSCUs. Alternatively, the functionality of BSCU 106 and EBACs 108/110 may be combined into a single processor-based feature or component. In one embodiment, each EBAC is realized with a computer processor (such as a PowerPC 555) that hosts software, provides external interfaces for the software, and includes suitable processing logic that is configured to carry out the various EBAC operations described herein. In this embodiment, each EBAC 108/110 obtains its respective EBAC control signals from BSCU 106, processes the EBAC control signals, and generates the brake mechanism control signals for the aircraft brake assembly.

Each wheel may include an associated brake mechanism and actuator. Consequently, braking and parking braking for each wheel may be independently and individually controlled by the electric brake system. Each electric brake actuator is suitably configured to receive actuator control signals from an EBAC, wherein the actuator control signals influence adjustment of the electric brake actuator. In this embodiment, each electric brake actuator in electric brake system 100 is coupled to and controlled by an EBAC. In this manner, EBACs 108/110 control the brake actuators to apply, release, modulate, and otherwise control the application of the parking brakes. In this regard, EBACs 108/110 generate the brake mechanism control signals in response to the respective EBAC control signals generated by BSCU 106. The brake mechanism control signals are suitably formatted and arranged for compatibility with the particular brake mechanism utilized by the aircraft. Those skilled in the art are familiar with aircraft brake mechanisms and the general manner in which they are controlled, and such known aspects will not be described in detail here.

The left side electric brake subsystem architecture 102 may include or cooperate with a suitably configured power control subsystem 140. Power control subsystem 140 may be coupled to EBACs 108/110 (and/or to other components of electric brake system 100), and power control subsystem 140 may be configured to remove power to the electric brake actuators as needed. For example, power control subsystem 140 can remove power to the electric brake actuators and/or other components of left side electric brake subsystem architecture 102 after engagement of the friction brakes, which maintain the braking force needed for the parking brake.

The right side electric brake subsystem architecture 103 has a structure that is similar to the left side electric brake subsystem architecture 102. For this example deployment, as shown in FIG. 1, the right side electric brake subsystem architecture 103 may include, without limitation: a pilot parking brake lever 104, which may be shared with left side electric brake subsystem architecture 102; a BSCU 146; an inboard EBAC 148; an outboard EBAC 150; an inboard wheel group 152; an outboard wheel group 154; electric brake actuators (reference numbers 164, 168, 172, and 176), and friction brakes (reference numbers 166, 170, 174, and 178) corresponding to their respective wheels (reference numbers 156, 158, 160, and 162). These components are coupled together to operate as described above for left side electric brake subsystem architecture 102, however, the right-side processing is preferably independent of the left-side processing. Also, the right side electric brake subsystem architecture 103 has a dedicated power control subsystem 180.

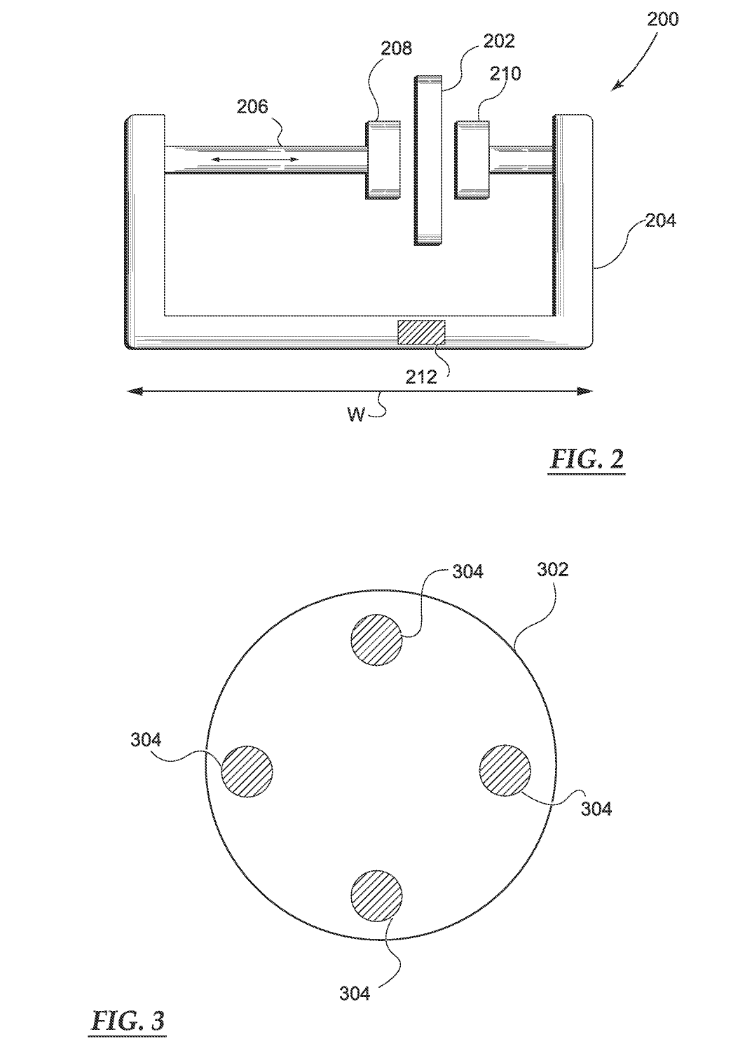

FIG. 2 is a diagram that schematically illustrates thermal expansion and contraction of an aircraft brake mechanism 200. An actual deployment of brake mechanism 200 will be realized in a much more complex and detailed manner—FIG. 2 is merely being used here as a visual and conceptual tool. Brake mechanism 200 generally includes a rotor 202, a torque tube 204 or other suitably configured frame or support structure, an electric brake actuator 206, a stator 208 coupled to electric brake actuator 206, and a fixed stator 210 coupled to torque tube 204. Brake mechanism 200 may also include an instrument 212 that is configured to measure temperature of a component of brake mechanism 200. In this example, instrument 212 measures the temperature of rotor 202.

FIG. 2 depicts an edge view of rotor 202. Rotor 202 is coupled to a wheel of an aircraft, which rotates along with rotor 202. In this regard, brake mechanism 200 may be located within the hub of the wheel. FIG. 3 is a side view illustrating brake actuator placement relative to a brake rotor 302. FIG. 3 shows a practical embodiment where four electric brake actuators 304 are utilized for one rotor 302. Rotor 302 (and the wheel coupled to rotor 302) rotates about an axis that runs through the center of rotor 302. In FIG. 3, this axis would be perpendicular to the page; in FIG. 2, this axis would be horizontal.

In operation, torque tube 204 and fixed stator 210 remain stationary, while the position of electric brake actuator 206 relative to torque tube 204 and fixed stator 210 is controlled by an EBAC. To apply braking force, electric brake actuator 206 is driven such that stator 208 moves (to the right in FIG. 2) and clamps rotor 202 against fixed stator 210. When the aircraft is parked and the parking brake is engaged, the clamped position of electric brake actuator 206 is held in place by any suitable means, e.g., a friction brake. To release the braking force or to disengage the parking brake, electric brake actuator 206 is controlled such that stator 208 moves (to the left in FIG. 2) and reduces the clamping force on rotor 202.

After landing, brake mechanism 200 is actuated to decelerate the aircraft. The engagement of brake mechanism 200 results in heating of rotor 202. The actual temperature of rotor 202 will be dependent upon the amount of energy absorbed by brake mechanism 200. In practice, the temperature can be as high as 2500 degrees Fahrenheit. This heat may be transferred to other components of brake mechanism 200, such as torque tube 204, resulting in thermal expansion. Thus, in FIG. 2, the width (W) of torque tube 204 changes in response to transient thermal conditions of brake mechanism 200. If the parking brake is set when brake mechanism 200 is still experiencing thermal expansion or contraction, then the clamping force administered by electric brake actuator 206 may become too low (if the width of torque tube 204 is expanding) or too high (if the width of torque tube 204 is contracting).

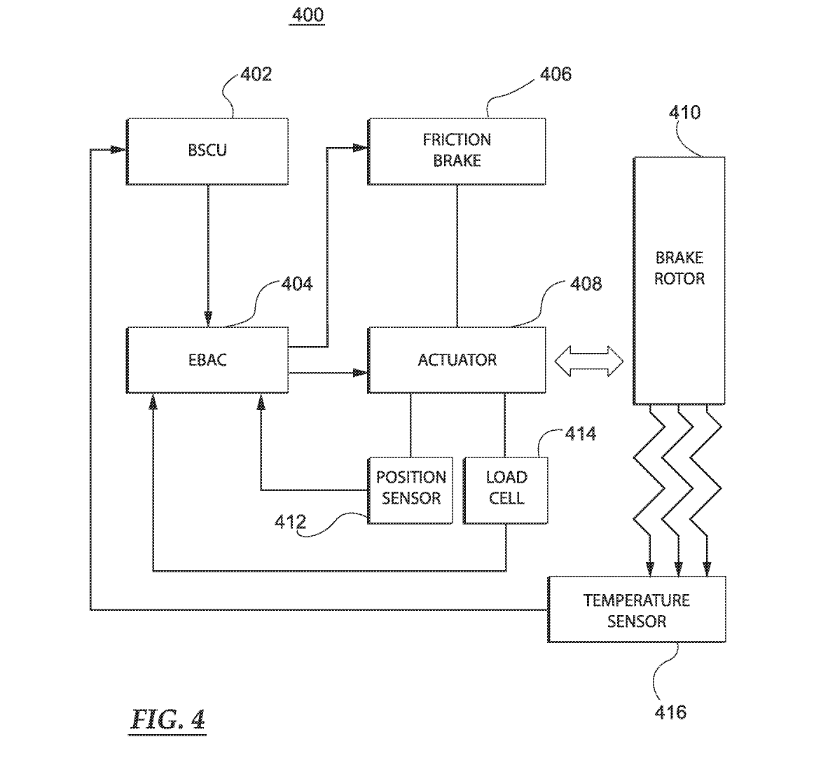

FIG. 4 is a block diagram that illustrates several components of an electric brake system 400. These components may be implemented in electric brake system 100 (see FIG. 1). Electric brake system 400 may include, without limitation: a BSCU 402; an EBAC 404 coupled to BSCU 402; a friction brake 406 coupled to and controlled by EBAC 404; an electric brake actuator 408 coupled to and controlled by EBAC 404; and a brake rotor 410 (as described above in connection with FIG. 2 and FIG. 3). FIG. 4 depicts a simplified electric brake system 400. In practice, an embodiment may include more than one BSCU, more than one EBAC, more than one friction brake, and more than one electric brake actuator for each brake rotor. Electric brake system 400 may include one or more sensors, instruments, or transducers, including, without limitation: an actuator position sensor 412; a load cell 414 or any suitably configured instrument that measures clamping force of electric brake actuator 408; and a temperature sensor 416 or thermocouple configured to measure a temperature that is indicative of the temperature of brake rotor 410. The components shown in FIG. 4 may be coupled together via a data communication bus or any suitably configured interconnection arrangement or architecture.

BSCU 402 may be configured to operate as described above for BSCU 106 (see FIG. 1), and EBAC 404 may be configured to operate as described above for EBACs 108/110 (see FIG. 1). Notably, EBAC 404, under the control of BSCU 402, controls the position of electric brake actuator 408 and, consequently, the brake torque/pressure applied to brake rotor 410. EBAC 404 may receive feedback data from actuator position sensor 412 and/or from load cell 414 to enable electric brake system 400 to determine whether electric brake actuator 408 is sufficiently engaged. For example, a desired parking brake actuation state can be achieved when the measured position of electric brake actuator 408 reaches a designated threshold position as detected by actuator position sensor 412. Alternatively (or additionally), the desired parking brake actuation state can be achieved when the measured clamping force of electric brake actuator 408 reaches a designated threshold clamping force as detected by load cell 414.

Brake rotor 410 may be configured as described above for rotor 202 (see FIG. 2) and rotor 302 (see FIG. 3). In one embodiment, temperature sensor 416 measures the current temperature of brake rotor 410 (or a temperature that is based on the current temperature of brake rotor 410). This measured temperature may be processed by electric brake system 400 to determine when it might be necessary to make a parking brake adjustment. In this regard, temperature sensor 416 may provide its temperature data to BSCU 402 (as shown) and/or to EBAC 404. In turn, BSCU 402 may process the temperature data directly to determine whether to adjust electric brake actuator 408 and/or process the temperature data to derive an adjustment schedule or time periods associated with the adjustment of electric brake actuator 408.

Friction brake 406 is suitably configured to maintain the parking brake mechanism in a deployed condition. Accordingly, friction brake 406 cooperates with, and may be coupled to, electric brake actuator 408. Friction brake 406 represents a mechanical means for engaging electric brake actuator 408. In other words, friction brake 406 is configured to hold electric brake actuator 408 in place even though operating power is removed from electric brake actuator 408. Friction brake 406 allows the parking brake mechanism to remain engaged without drawing an excessive amount of power from the aircraft battery. In this example, EBAC 404 controls the application of friction brake 406 using suitably formatted control signals.

In one embodiment, BSCU 402 and/or EBAC 404 may be pre-programmed with data that is indicative of estimated thermally induced dimensional changes of the parking brake mechanism. Such data may be dependent upon various factors including, without limitation: the transient thermal characteristics of the aircraft parking brake mechanism; the shape, size, and configuration of the brake mechanism; the expected range of operating temperatures for the brake mechanism; the average time between landing and engagement of the parking brake; the average cool down time for the brake mechanism following landing and braking; threshold times related to parking brake adjustment periods and cycles; threshold clamping forces associated with desired parking brake actuation states; and threshold actuator positions associated with desired parking brake actuation states.

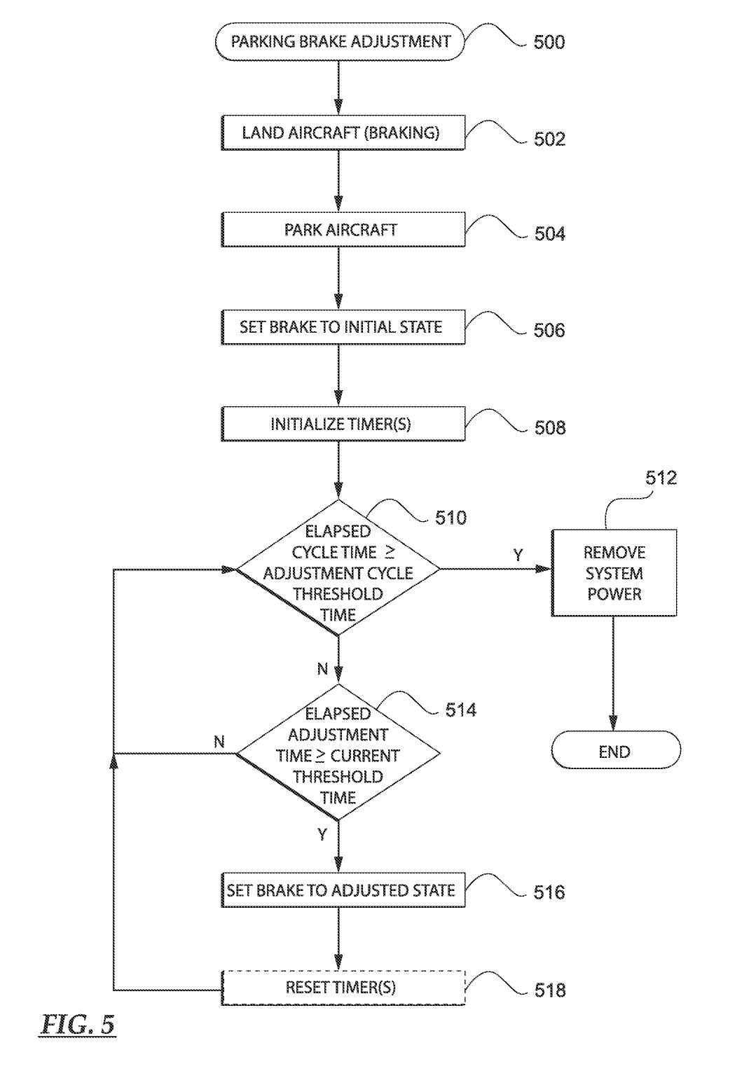

FIGS. 5-7 are flow charts representing processes for setting and adjusting an aircraft parking brake. For illustrative purposes, the following description of these processes may refer to elements mentioned above in connection with FIGS. 1-4. In practice, portions of these processes may be performed by different elements of the described system. Moreover, the tasks shown in FIGS. 5-7 are not necessarily exhaustive, nor are all of the tasks shown necessary in every embodiment of the processes. It should be appreciated that these processes may include any number of additional or alternative tasks, the tasks shown in FIGS. 5-7 need not be performed in the illustrated order, and that any of the processes may be incorporated into a more comprehensive procedure or method having additional functionality not described in detail herein.

FIG. 5 is a flow chart of a parking brake adjustment process 500, where adjustments are made at threshold times. Process 500 can be performed whenever the aircraft parking brake is engaged. This usually occurs shortly after landing the aircraft. Briefly, process 500 initially sets the parking brake, periodically adjusts the electric brake actuator to compensate for thermal expansion/contraction of the brake mechanism, and eventually removes power to the electric brake system after the brake mechanism has cooled down. In practice, the electric brake system can be initialized by programming its BSCUs and/or EBACs with parameters, threshold values, and possibly other data that might be used by process 500 (see above description of BSCU 402 and EBAC 404).

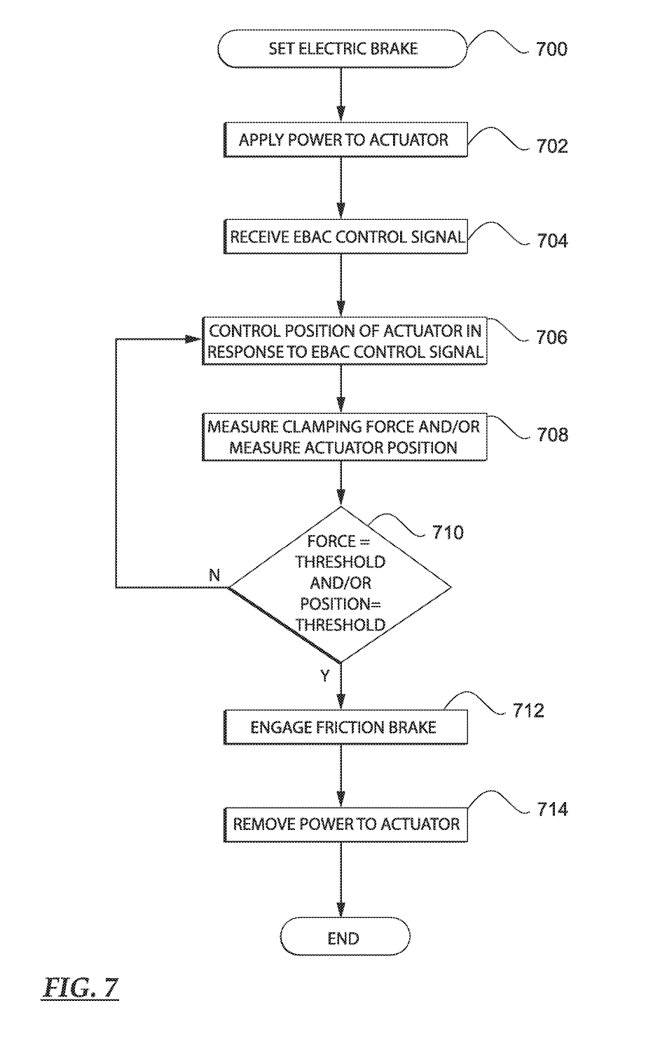

Parking brake adjustment process 500 may be responsive to the landing of the aircraft (task 502), during which the brake system is deployed to decelerate the aircraft. This type of braking can result in a tremendous increase in the brake mechanism and brake rotor, and temperatures in the range of 1000 degrees Fahrenheit may be reached. The aircraft will usually taxi for awhile, during which the temperature of the brake mechanism and brake rotor may continue to rise. After the aircraft is parked (task 504), the parking brake is set (task 506) to achieve an initial parking brake actuation state. In one embodiment, the electric brake actuators are set with the EBACs to achieve this initial actuation state. This procedure is described in more detail below in conjunction with FIG. 7.

Parking brake adjustment process 500 may utilize any number of timers or clocks to control when the electric brake actuators are adjusted. For example, one timer may be utilized to measure or monitor the elapsed time between parking brake adjustments (the “adjustment timer”). Another timer may be utilized to measure or monitor an overall elapsed time corresponding to the entire adjustment cycle (the “cycle timer”). Alternatively, process 500 may use a single timer for both purposes. These timers may be maintained by the BSCUs, the EBACs, and/or other components of the electric brake system. Moreover, parking brake adjustment process 500 may initialize one or more timers (task 508) at appropriate time(s). For example, task 508 may start the adjustment timer (and/or the cycle timer) when the initial parking brake actuation state has been achieved, when the aircraft touches down, when the aircraft reaches taxi speed, or the like. This example assumes that both timers are initialized in response to the initial setting of the electric brake actuator (see task 506).

The cycle timer is configured to measure an elapsed cycle time based upon its initialization time. Parking brake adjustment process 500 compares the current elapsed cycle time to an adjustment cycle threshold time (query task 510), which determines whether the brake mechanism has sufficiently cooled down. In this regard, the adjustment cycle threshold time represents a time at which the transient thermal characteristics of the aircraft parking brake mechanism have substantially stabilized. In other words, the adjustment cycle threshold time indicates a cool down time where, after the cool down time, thermal contraction of the brake mechanism is negligible for purposes of parking brake adjustments. Thus, the adjustment cycle threshold time is a function of the transient thermal characteristics of the parking brake mechanism. In practice, the adjustment cycle threshold time may be a pre-programmed parameter that is derived from empirical or simulation data, or it may be a variable parameter that is calculated from a measured temperature of a component of the brake mechanism. As an example, the adjustment cycle threshold time may be approximately 30 minutes, which is usually sufficient for cooling of an aircraft brake mechanism after landing.

After the elapsed cycle time reaches the adjustment cycle threshold time (query task 510), parking brake adjustment process 500 removes or reduces power to the electric brake system (task 512) and process 500 ends. As described in more detail below in connection with FIG. 7, the electric brake actuator is held in place using a friction brake and, therefore, it can be safely powered down without losing the parking brake force. Task 512 may be performed to prevent excessive drain of the main aircraft battery.

If the adjustment cycle threshold time has not been reached, then query task 510 may lead to a query task 514. The adjustment timer is configured to measure an elapsed iteration time based upon its initialization time. Parking brake adjustment process 500 compares the current elapsed adjustment time to a current threshold time (query task 514), which determines whether the parking brake should be readjusted. In this regard, the current threshold time represents a time at which thermally induced dimensional changes (contraction or expansion) of the aircraft parking brake mechanism warrant readjustment of the electric brake actuator. Thus, the threshold time for each adjustment iteration may be a function of the transient thermal characteristics of the parking brake mechanism. In practice, the various threshold times may be pre-programmed parameters that are derived from empirical or simulation data, or each threshold time may be a variable parameter that is calculated from a measured temperature of a component of the brake mechanism (e.g., the brake rotor).

If the elapsed adjustment time has not yet reached the current threshold time, then parking brake adjustment process 500 may be re-entered at query task 510. After the elapsed adjustment time reaches the current threshold time, process 500 may then set the parking brake (task 516) to achieve an adjusted parking brake actuation state that compensates for the transient thermal characteristics of the aircraft parking brake mechanism. In one embodiment, the EBACs control the electric brake actuators to achieve the adjusted actuation state. This procedure is described in more detail below in conjunction with FIG. 7.

As an optional step, parking brake adjustment process 500 may reset the adjustment timer and/or the cycle timer (task 518) before re-entering query task 510. For example, the adjustment timer may be reset to enable independent measurement of the adjustment time period for each iteration. In addition, the next iteration of query task 510 may be based upon a new adjustment cycle threshold time. Process 500 may use different adjustment cycle threshold times to contemplate the transient thermal characteristics of the brake mechanism. For example, it might be desirable to use relatively short adjustment time periods shortly after landing (when the brake mechanism is very hot) and relatively long adjustment time periods near the end of the overall adjustment cycle (when the temperature of the brake mechanism is beginning to stabilize).

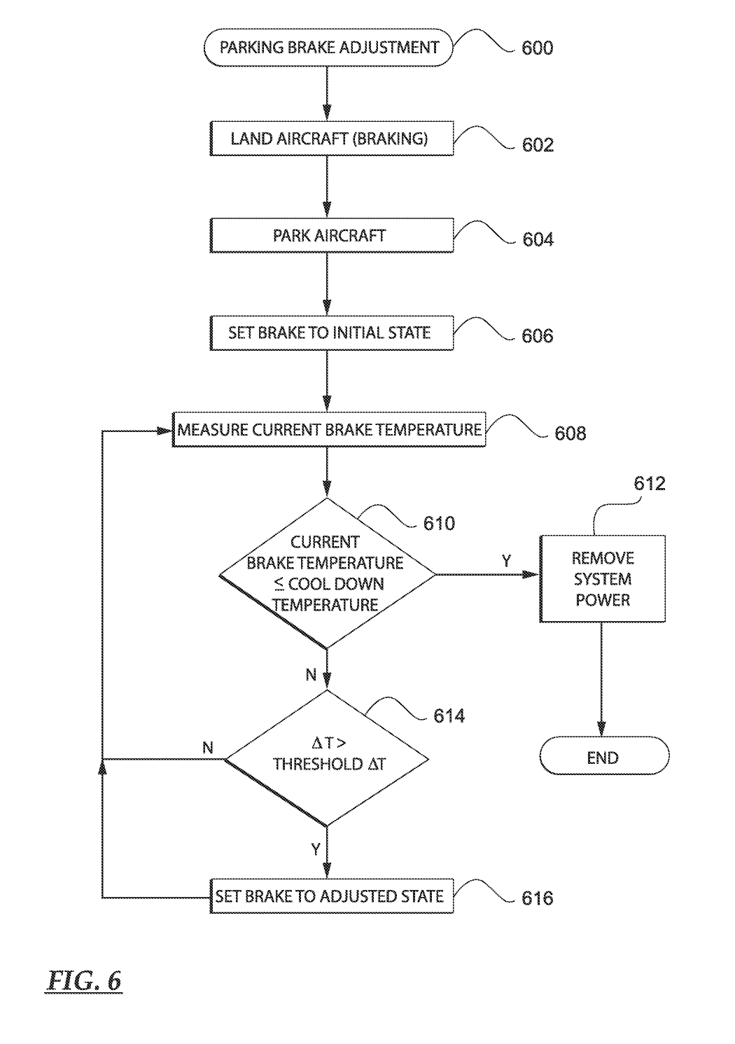

FIG. 6 is a flow chart of a parking brake adjustment process 600, where adjustments are made based on measured temperatures. Certain aspects of process 600 are similar or equivalent to aspects of parking brake adjustment process 500, and such common features and aspects will not be redundantly described in the context of process 600.

Parking brake adjustment process 600 may be responsive to the landing of the aircraft (task 602), which causes the brake mechanisms to heat. After the aircraft is parked (task 604), the parking brake is set (task 606) to achieve an initial parking brake actuation state. This procedure is described in more detail below in conjunction with FIG. 7.

Parking brake adjustment process 600 measures a temperature of a component of the parking brake mechanism (task 608). This temperature may represent a direct measurement of the component or an indirect measurement of the component. In this example, task 608 measures the current temperature of one or more brake rotors. The electric brake system may include a suitably configured temperature sensor or thermocouple that facilitates constant monitoring of the real-time temperature of the brake mechanism. Process 600 may compare the current measured temperature to a cool down temperature (query task 610) that indicates whether the brake mechanism has sufficiently cooled down. In this regard, the cool down temperature represents a temperature at which the transient thermal characteristics of the aircraft parking brake mechanism have substantially stabilized. In other words, the cool down temperature indicates that thermal contraction of the brake mechanism is negligible for purposes of parking brake adjustments. Thus, the cool down temperature is a function of the transient thermal characteristics of the parking brake mechanism. In practice, the cool down temperature may be a pre-programmed parameter that is derived from empirical or simulation data.

If the measured temperature has reached the cool down temperature (query task 610), parking brake adjustment process 600 removes or reduces power to the electric brake system (task 612) and process 600 ends. As described in more detail below in connection with FIG. 7, the electric brake actuator is held in place using a friction brake and, therefore, it can be safely powered down without losing the parking brake force. Task 612 may be performed to prevent excessive drain of the main aircraft battery. If the brake mechanism has not reached the designated cool down temperature, then query task 610 may lead to a query task 614.

In this embodiment, parking brake adjustment process 600 determines whether the measured temperature is changing by comparing the measured temperature to a previously measured temperature (or to a programmed default or initial temperature value). Query task 614 compares the difference between these two temperatures (i.e., the current ΔT) to a current threshold temperature change (i.e., a threshold ΔT) to determine whether the parking brake should be readjusted. In this regard, the current threshold ΔT indicates that thermally induced dimensional changes (contraction or expansion) of the aircraft parking brake mechanism warrant readjustment of the electric brake actuator. Thus, the threshold ΔT for each adjustment iteration may be a function of the transient thermal characteristics of the parking brake mechanism. In practice, the various threshold ΔT values may be pre-programmed parameters that are derived from empirical or simulation data.

If the current ΔT value has not yet reached the current threshold ΔT value, then parking brake adjustment process 600 may be re-entered at query task 608 to continue monitoring and measuring the brake temperature. If a change in the measured temperature is greater than the current threshold ΔT value, then process 600 sets the parking brake (task 616) to achieve an adjusted parking brake actuation state that compensates for the transient thermal characteristics of the aircraft parking brake mechanism. In one embodiment, the EBACs control the electric brake actuators to achieve the adjusted actuation state. This procedure is described in more detail below in conjunction with FIG. 7.

Following task 616, process 600 may be re-entered at query task 608. The next iteration of query task 610 may be based upon a new threshold ΔT value. Process 600 may use different threshold ΔT values to contemplate the transient thermal characteristics of the brake mechanism. For example, it might be desirable to use relatively low threshold ΔT values shortly after landing (when the brake mechanism is very hot) and relatively high threshold ΔT values near the end of the overall adjustment cycle (when the temperature of the brake mechanism is beginning to stabilize).

FIG. 7 is a flow chart of a process 700 for setting an electric brake. Process 700 may be performed during parking brake adjustment process 500 and during parking brake adjustment process 600 to set the initial parking brake actuation states and to set the adjusted parking brake actuation states (see the above description of tasks 506, 516, 606, and 616).

Electric brake setting process 700 may begin by applying or maintaining power to one or more electric brake actuators in the electric brake system (task 702). As mentioned above, the electric brake actuators are controlled by the EBACs. Thus, process 700 receives the EBAC control signals (task 704) that govern the actuation of the electric brake actuators, and controls the position of the electric brake actuators in response to the EBAC control signals (task 706). The electric brake system may utilize any suitable technique to determine when the desired braking condition has been satisfied. For example, the electric brake system may measure a clamping force of an electric brake actuator and/or measure a position of an electric brake actuator (task 708), and compare the measured quantity or quantities to appropriate threshold values.

Electric brake setting process 700 may compare the measured clamping force to a threshold clamping force and/or compare the measured position of the electric brake actuator to a threshold position (query task 710). In one embodiment, the threshold clamping force remains the same throughout the entire parking brake adjustment procedure because the clamping force required to engage the parking brake is independent of the changing dimensions of the brake mechanism. The threshold actuator position, however, may vary during the parking brake adjustment procedure to compensate for thermal expansion/contraction of the brake mechanism. If the measured clamping force has not reached the threshold clamping force, and/or if the measured actuator position has not reached the threshold position, then process 700 may be re-entered at task 706 to continue controlling the position of the electric brake actuator.

If the measured clamping force has reached the threshold clamping force, and/or if the measured actuator position has reached the threshold position, then the desired parking brake actuation state has been achieved. Thereafter, electric brake setting process 700 may engage one or more friction brakes (task 712) to maintain the parking brake mechanism in a deployed condition. The friction brakes are configured to mechanically hold the electric brake actuators in place. Consequently, process 700 can remove power to the electric brake actuators (task 714) after engaging the friction brakes. At this point, process 700 has achieved the desired parking brake actuation state (which may either be the initial actuation state or a subsequent adjusted actuation state). The electric brake system described herein is configured to reapply power to the electric brake actuators as needed such that the electric brake actuators can be electrically repositioned in the manner described above.

The measured clamping force may also be monitored to determine when it might be necessary to adjust the parking brake in response to thermal expansion/contraction of the brake mechanism components. For example, expansion of the brake mechanism may result in a decrease in the nominal clamping force, while contraction of the brake mechanism may result in an increase in the nominal clamping force. The parking brake adjustment technique described herein can be modified such that deviations in the nominal clamping force trigger an adjustment cycle.

Electric brake setting process 700, in conjunction with parking brake adjustment process 500 and/or parking brake adjustment process 600, allows the electric brake system to perform a parking brake adjustment cycle that accommodates thermal expansion and contraction of the brake mechanisms. This adjustment cycle includes periodically: controlling the electric brake actuators to achieve the desired parking brake state; engaging the friction brakes; removing power to the electric brake actuators; reapplying power to the electric brake actuators; disengaging the friction brakes; electrically adjusting the electric brake actuators; and reengaging the friction brakes. This periodic procedure can be repeated as needed until the aircraft brake mechanism has cooled down to a point where thermal contraction has little or no effect on the operation of the parking brake and little or no adverse effect on the brake system components.

While at least one example embodiment has been presented in the foregoing detailed description, it should be appreciated that a vast number of variations exist. It should also be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention, where the scope of the invention is defined by the claims, which includes known equivalents and foreseeable equivalents at the time of filing this patent application.

What is claimed is:

1. A method for adjusting an aircraft parking brake mechanism in an electric brake system having a brake system control unit, an electric brake actuator control coupled to the brake system control unit, and an electric brake actuator coupled to the electric brake actuator control, the method comprising:
setting the electric brake actuator with the electric brake actuator control to achieve an initial parking brake actuation state; and
thereafter controlling the electric brake actuator with the electric brake actuator control to achieve an adjusted parking brake actuation state that compensates for transient thermal characteristics of the aircraft parking brake mechanism.

2. A method according to claim 1, further comprising:
measuring an elapsed time; and
comparing the elapsed time to a threshold time; wherein
controlling the electric brake actuator occurs after the elapsed time reaches the threshold time.

3. A method according to claim 2, further comprising programming the brake system control unit with the threshold time, the threshold time being a function of the transient thermal characteristics of the aircraft parking brake mechanism.

4. A method according to claim 2, further comprising:
measuring a temperature of a component of the aircraft parking brake mechanism; and
calculating the threshold time from the measured temperature.

5. A method according to claim 1, further comprising:
engaging a friction brake, after achieving the initial parking brake actuation state, to maintain the parking brake mechanism in a deployed condition;
thereafter removing power to the electric brake actuator; and
reapplying power to the electric brake actuator before controlling the electric brake actuator.

6. A method according to claim 1, further comprising:
measuring a clamping force of the electric brake actuator; and
comparing the measured electric brake actuator clamping force to a threshold clamping force; wherein:
the initial parking brake actuation state is achieved when the measured electric brake actuator clamping force reaches the threshold clamping force; and
the adjusted parking brake actuation state is achieved when the measured electric brake actuator clamping force reaches the threshold clamping force.

7. A method according to claim 1, further comprising measuring a position of the electric brake actuator; wherein:
the initial parking brake actuation state is achieved when the measured position of the electric brake actuator reaches a first threshold position; and
the adjusted parking brake actuation state is achieved when the measured position of the electric brake actuator reaches a second threshold position.

8. A method according to claim 1, further comprising:
measuring an elapsed time;
comparing the elapsed time to an adjustment cycle threshold time; and
removing power to the electric brake system after the elapsed time reaches the adjustment cycle threshold time, the adjustment cycle threshold time being a time at which the transient thermal characteristics of the aircraft parking brake mechanism have substantially stabilized.

9. A method for adjusting a parking brake mechanism for an aircraft having an electric brake system, the method comprising:
setting the parking brake mechanism using an electric brake actuator to achieve an initial parking brake actuation state;
measuring a temperature of a component of the parking brake mechanism;
determining whether the measured temperature is changing by comparing the measured temperature to a previous measured temperature; and
controlling the parking brake mechanism to achieve an adjusted parking brake actuation state if a change in the measured temperature is greater than a threshold temperature variation.

10. A method according to claim 9, further comprising:
engaging a friction brake, after achieving the initial parking brake actuation state, to maintain the parking brake mechanism in a deployed condition;
thereafter removing power to the electric brake actuator; and
reapplying power to the electric brake actuator before controlling the parking brake mechanism.

11. A method according to claim 9, further comprising:
measuring a clamping force of the electric brake actuator; and
comparing the measured electric brake actuator clamping force to a threshold clamping force; wherein:
the initial parking brake actuation state is achieved when the measured electric brake actuator clamping force reaches the threshold clamping force; and
the adjusted parking brake actuation state is achieved when the measured electric brake actuator clamping force reaches the threshold clamping force.

12. A method according to claim 9, further comprising measuring a position of the electric brake actuator; wherein:
the initial parking brake actuation state is achieved when the measured position of the electric brake actuator reaches a first threshold position; and
the adjusted parking brake actuation state is achieved when the measured position of the electric brake actuator reaches a second threshold position.

13. A method according to claim 9, further comprising removing power to the electric brake system after completion of a parking brake adjustment cycle.

14. An aircraft electric brake system comprising:
a parking brake mechanism;
a brake system control unit configured to generate brake control signals that compensate for thermally induced dimensional changes of the parking brake mechanism;
an electric brake actuator control coupled to and controlled by the brake system control unit; and
an electric brake actuator coupled to and controlled by the electric brake actuator control, the electric brake actuator being configured to receive actuator control signals from the electric brake actuator control, wherein the actuator control signals influence adjustment of the electric brake actuator.

15. A system according to claim 14, further comprising:
a mechanical component configured to maintain the parking brake mechanism in a deployed condition; and
a power control subsystem coupled to the electric brake actuator control, the power control subsystem being configured to remove power to the electric brake actuator after engagement of the mechanical component.

16. A system according to claim 15, wherein the brake system control unit is configured to perform a parking brake adjustment cycle that comprises periodically disengaging the mechanical component and reapplying power to the electric brake actuator, and subsequently engaging the mechanical component and removing power to the electric brake actuator.

17. A system according to claim 16, wherein the electric brake system is configured to remove its input power after completion of the parking brake adjustment cycle.

18. A system according to claim 14, wherein the brake system control unit is programmed with data indicative of estimated thermally induced dimensional changes of the parking brake mechanism.

19. A system according to claim 14, further comprising an instrument coupled to the brake system control unit, wherein:
the instrument is configured to measure temperature of a component of the parking brake mechanism;
the brake system control unit is configured to compare the measured temperature to a threshold temperature; and
the brake system control unit is configured to control the parking brake mechanism to achieve an adjusted parking brake actuation state based upon the difference between the measured temperature and the threshold temperature.

20. A system according to claim 14, further comprising a sensor coupled to the brake system control unit, wherein:
the sensor is configured to measure an electric brake actuator clamping force;
the electric brake actuator control is configured to compare the measured electric brake actuator clamping force to a threshold clamping force; and
the electric brake actuator control is configured to control the parking brake mechanism to achieve an adjusted parking brake actuation state when the measured electric brake actuator clamping force reaches the threshold clamping force.
